(19) United States
(12) Patent Application Publication
(10) Pub. No.: US 2012/0038813 A1
(43) Pub. Date: Feb. 16, 2012

(54) CAMERA MODULE

(75) Inventors: Young-Gyu JUNG, Cheongju-si (KR); Yung-Cheol Kong, Cheonan-si (KR); Tai-Hyun Eum, Seoul (KR); Han-Sung Ryu, Yongin-si (KR); Yu-Jung Tae, Seoul (KR)

(73) Assignee: Samsung Electronics Co., Ltd, Suwon-si (KR)

(21) Appl. No.: 13/185,769

(22) Filed: Jul. 19, 2011

(30) Foreign Application Priority Data
Aug. 16, 2010 (KR) 10-2010-0078906

(51) Int. Cl. H04N 5/225

(52) U.S. Cl. 348/340; 348/E05.024

(57) ABSTRACT

A camera module includes an image sensor package including an image sensor chip and a chip cover layer protecting the image sensor chip, a first lens disposed above the image sensor package to be coupled with an upper surface of the chip cover layer, a second lens disposed over the first lens, and an infrared blocking film formed in direct contact with the upper surface of the chip cover layer or an upper surface of the second lens.

### CROSS-REFERENCE TO RELATED APPLICATIONS

This application claims priority under 35 U.S.C. §119 from Korean Patent Application No. 10-2010-0078906 filed on Aug. 16, 2010 in the Korean Intellectual Property Office, the contents of which in its entirety are herein incorporated by reference.

### BACKGROUND OF THE INVENTION

1. Field of the Invention

The present general inventive concept relates to a camera module, and more particular, an image sensor package, a camera module having the image sensor package, and an apparatus having the same.

2. Description of the Related Art

Recently, a digital camera function is frequently used in an electronic apparatus according to the development of Internet video communication. In next-generation mobile communications, there is an increasing demand for a small-sized camera module having a relatively small information communication terminal to be used in image communications. That is, there is a greatly increasing demand for a subminiature camera module which is directly or indirectly associated with production of a high performance and multifunction digital camera.

Particularly, a camera used in an electronic apparatus, for example, a mobile phone, for mobile communications adopts a small camera module. In the structure of the camera module, the most important factor is a size of the camera module because the size of the mobile phone increases as the size of the camera module increases.

### SUMMARY OF THE INVENTION

The present general inventive concept provides a camera module capable of minimizing a total length of an optical system or an electronic apparatus.

Additional aspects and advantages of the present general inventive concept will be set forth in part in the description which follows and, in part, will be obvious from the description, or may be learned by practice of the general inventive concept

According to an embodiment and utilities of the present general inventive concept, there is provided a camera module including an image sensor package including an image sensor chip and a chip cover layer to protect the image sensor chip, a first lens disposed above the image sensor package to be coupled with an upper surface of the chip cover layer, a second lens disposed over the first lens, and an infrared blocking film formed in direct contact with the upper surface of the chip cover layer or an upper surface of the second lens.

According to an embodiment and utilities of the present general inventive concept, there is provided a camera module including an image sensor package including an image sensor chip and a chip cover layer to protect the image sensor chip, and an optical system arranged in a path of light incident onto the image sensor chip, wherein the optical system may include an objective lens including a first surface having a positive refractive power and a second surface having a negative refractive power, a plano-convex lens to be coupled with an upper surface of the chip cover layer, and an infrared blocking film formed in direct contact with the upper surface of the chip cover layer or an upper surface of the plano-convex lens.

According to an embodiment and utilities of the present general inventive concept, there is provided a camera module including an image sensor package including an image sensor chip and a chip cover layer protecting the image sensor chip, an optical system arranged in a path of light to be incident onto the image sensor chip, the optical system having a first lens disposed above the image sensor package to be coupled with an upper surface of the chip cover layer, a second lens disposed above the first lens, and an infrared blocking film formed in direct contact with one of the upper surface of the chip cover layer and an upper surface of the first lens.

The camera module may further include a housing to accommodate the image sensor package and the optical system.

The optical system may further include a barrel fixed to the second lens, and the barrel may be fixed to the housing to support the second lens with respect to the housing and the first lens of the optical system.

The camera module may further include an insulation layer formed to protect the housing, and the housing may be electrically connected to the image sensor package.

According to an embodiment and utilities of the present general inventive concept, there is provided an electronic apparatus including an interface to communicate with an external device, a camera module, and a controller having a major substrate connected to the camera module to receive a signal from the camera module, and connected to the interface to communicate with the external device to transmit data corresponding to the signal. The camera module may include an image sensor package including an image sensor chip and a chip cover layer protecting the image sensor chip, an optical system arranged in a path of light to be incident onto the image sensor chip, the optical system having a first lens disposed above the image sensor package to be coupled with an upper surface of the chip cover layer, a second lens disposed above the first lens, and an infrared blocking film formed in direct contact with one of the upper surface of the chip cover layer and an upper surface of the first lens.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 illustrates a cross sectional view of a camera module in accordance with an embodiment of the present general inventive concept;

FIG. 2 illustrates a cross sectional view of a camera module in accordance with another embodiment of the present general inventive concept;

FIG. 3 illustrates a cross sectional view of a camera module in accordance with still another embodiment of the present general inventive concept;

FIG. 4 illustrates a cross sectional view illustrating an optical system of a camera module in accordance with the embodiment of the present general inventive concept;

FIGS. 5 to 8 illustrate cross sectional views illustrating a method of forming an image sensor package with an infrared blocking film and a first lens on a chip cover layer in accordance with the embodiment of the present general inventive concept;

FIGS. 9A and 9B are views illustrating a camera module formed with an insulation layer in an electronic apparatus according to an embodiment of the present general inventive concept;

FIG. 10 is a flow chart illustrating a method of forming a camera module having an image sensor package and an electronic apparatus according to an embodiment of the present general inventive concept; and

FIG. 11 is a view illustrating an electronic apparatus having a camera module according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures. The present general inventive concept may, however, be embodied in many different forms and should not be construed as being limited to the embodiments set forth herein. Rather, these embodiments are provided so that this disclosure will be thorough and complete and will fully convey the concept of the general inventive concept to those skilled in the art, and the present general inventive concept will only be defined by the appended claims. In the drawings, sizes and relative sizes of layers and regions may be exaggerated for clarity.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being “on” another element or layer, the element or layer can be directly on another element or layer or intervening elements or layers may also be present. In contrast, when an element is referred to as being “directly on” another element or layer, there are no intervening elements or layers present. As used herein, the term “and/or” includes any and all combinations of one or more of the associated listed items.

Spatially relative terms, such as “below”, “beneath”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation, in addition to the orientation depicted in the figures. Throughout the specification, like reference numerals in the drawings denote like elements.

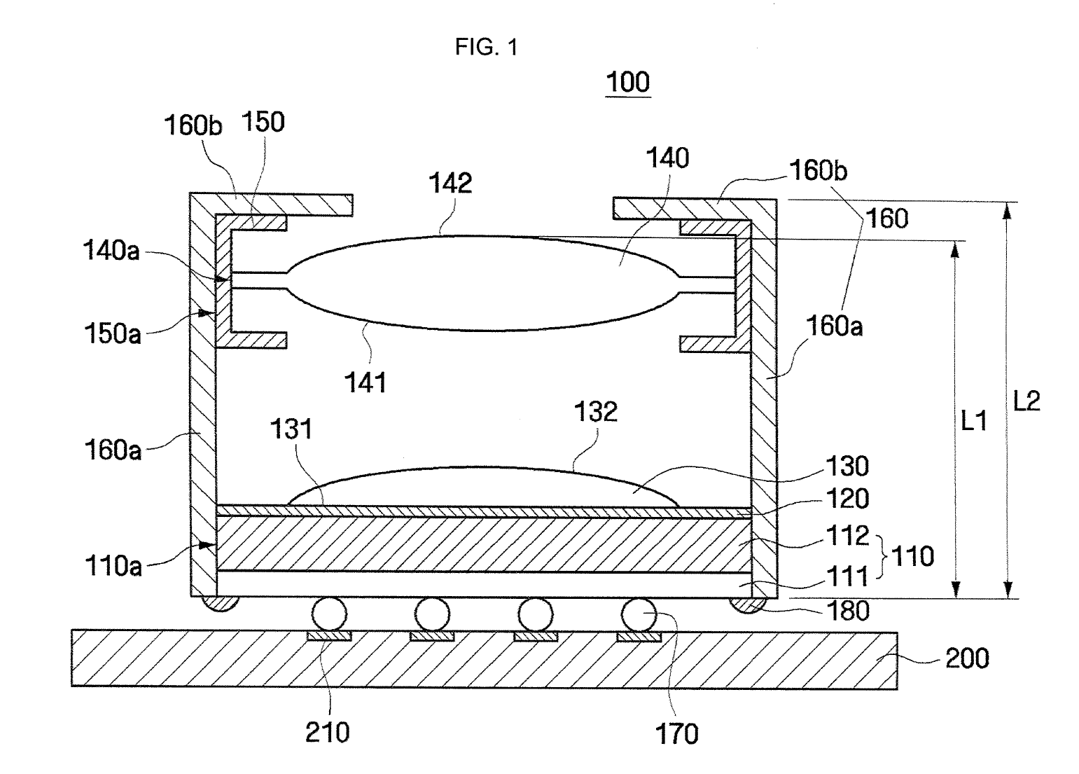

Hereinafter, a camera module according to an embodiment of the present general inventive concept will be described with reference to FIG. 1. FIG. 1 illustrates a cross sectional view of the camera module 100 according to the embodiment of the present general inventive concept.

Referring to FIG. 1, the camera module 100 in accordance with the embodiment of the present general inventive concept may include an image sensor package 110 including an image sensor chip 111 having an image region on which an image is formed from incident light. The image sensor chip 111 is an element which receives light and converts the light into an electric signal. The image sensor chip 111 may include a complementary metal oxide semiconductor (CMOS) image sensor chip or a charge coupled device (CCD) image sensor chip according to operation and manufacturing methods. The CCD image sensor chip is based on an analog circuit and employs a method in which light incident on a lens is distributed to plural cells, the respective cells store electric charges of the incident light, brightness is determined based on the magnitude of the electric charges, and an electrical signal corresponding to the brightness is transmitted to a converter of the image sensor package or the camera module 100 to represent colors. The CCD image sensor chip can provide a clear image quality. However, it is possible that the CCD image sensor chip may require high data storage capacity and may also cause high power consumption. Accordingly, it is widely used in an electronic apparatus, for example, a digital camera requiring a high image quality. The CMOS image sensor chip includes analog and digital signal processing circuits integrated in a semiconductor chip. The power consumption of the CMOS image sensor chip may be only one tenth of the power consumption of the CCD image sensor chip. The CMOS image sensor chip is configured as one chip satisfying the requirements to enable the manufacture of a small-sized product and is widely used in an electronic apparatus, such as a digital camera, a camera phone, a personal media player (PMP) and the like.

The image sensor package 110 may be an image sensor chip scale package (image sensor CSP) including the image sensor chip 111. The CSP (chip scale package or chip size package) has many advantages compared to a general plastic package. One of the advantages of the CSP is a size of the package. In accordance with the definition of the International Semiconductor Association such as Joint Electron Device Engineering Council (JEDEC) and Electronic Industry Association of Japan (EIAJ), the chip scale package refers to a package being equal to or less than 1.2 times as large as the size of a general chip. The chip scale package is mainly used in an electronic apparatus requiring a small size and portability. The electronic apparatus may include a digital camcorder, a mobile phone, a notebook computer and a memory card. A semiconductor device such as a digital signal process (DSP) chip, an application specific integrated circuit (ASIC) chip and a micro controller is mounted as an internal circuit to process an electrical signal corresponding to the light received through a lens unit in the chip scale package. Further, a chip scale package may have another internal circuit connected to the internal circuit to store programs or data corresponding to the process signal, for example, a memory device such as a dynamic random access memory (DRAM) and a flash memory. The image sensor chip 111 may have a through via connection structure. The through via connection structure means a structure formed with a through via on the image sensor to provide an electrical connection between an image sensor of the image sensor chip 111 and a circuit substrate through a through via formed in the image sensor. The through via may connect the internal circuits including the image sensor to the circuit substrate.

A chip cover layer 112 may be formed on the image sensor chip 111. The chip cover layer 112 may serve to protect the image sensor chip 111. The chip cover layer 112 is formed of a light-transmissive material, e.g., glass, a transparent resin material such as acrylic resin and polyester resin, a transparent metal oxide such as tin oxide and indium oxide, or the like. The chip cover layer 112 may have a flat plate shape having upper and lower planar surfaces.

An infrared (IR) blocking film 120 may be formed on the chip cover layer 112. The IR blocking film 120 is formed in direct contact with an upper surface of the chip cover layer 112. A human visible range is between 400 nm to 700 nm, and the image sensor detects light having a wavelength of 380 nm to 1,000 nm. Accordingly, the image sensor is more sensitive to infrared light than human eyes. Thus, the IR blocking film 120 may be required to block light in an infrared region before the infrared light is transmitted to the image sensor that is more sensitive to the infrared light, thereby to enhance color reproducibility. The IR blocking film 120 may be formed by coating an infrared blocking material to block the infrared light on the upper surface of the chip cover layer 112. The IR blocking film 120 may be formed by alternately depositing materials having different refractive indexes, e.g., TiO₂/SiO₂ or Ta₂O₅/SiO₂.

A first lens 130 that is coupled with the chip cover layer 112 is formed on the IR blocking film 120. The first lens 130 may be formed in direct contact with the IR blocking film 120. The first lens 130 may be a plano-convex lens. That is, a first surface 131 of the first lens 130 in contact with the IR blocking film 120 may be a flat surface, and a second surface 132 of the first lens 130 disposed opposite to the first surface 131 with respect to a body of the first lens 130 may be a convex surface. The second surface 132 may have a convex surface onto which light is incident and may have a positive refractive power. The second surface 132 may be a spherical surface or an aspherical surface.

A second lens 140 is arranged above the first lens 130. The second lens 140 is an objective lens. The second lens 140 may be a single lens having two spherical surfaces or aspherical surfaces. A first surface 141 of the second lens 140 close to the first lens 130 may have a negative refractive power and a second surface 142 of the second lens 140 disposed opposite to the first surface 141 with respect to a body of the second lens 140 may have a positive refractive power. The second lens 140 may be fixed in a barrel 150.

The first lens 130 and the second lens 140 may be a plastic lens or a glass lens. The plastic lens may be manufactured by mass production at a low unit production cost via injection molding. The glass lens may realize a megapixel high resolution.

A housing 160 may be provided to accommodate the image sensor package 110, the first lens 130, the second lens 140, and so on. The housing 160 may have sides 160a to correspond to lateral sides of the image sensor package 110 and the second lens 140. The housing 160 may have a structure enclosing side surfaces 140 of the second lens 140 and side surfaces 110a of the image sensor package 110. In this case, the side surface 110a of the image sensor chip 111 of the image sensor package 110 is not exposed to an outside thereof by the housing 160. Accordingly, it is possible to effectively shield the image sensor package 110 from electromagnetic waves.

When the second lens 140 is fixed to the barrel 150, the housing may have a structure enclosing a side surface 150a of the barrel 150. Therefore, the housing 160 may be provided to accommodate the image sensor package 110, the first lens 130, the barrel 150 with the second lens 140, and so on. The housing 160 may have a top 160b to provide a light passage through light is incident to the second lens 140. The top 160b of the housing may also support the barrel 150 with the second lens 140.

Meanwhile, the housing 160 may be electrically connected to the image sensor package 110 by, e.g., a conductive paste 180. The housing 160 may include a conductive material. For example, the housing 160 may be formed of a conductive material. Alternatively, the housing 160 may have a structure including a body formed of an insulating material and a conductive material surrounding an outer surface of the body. The insulating material may include a liquid crystal polymer (LCP), polycarbonate or polyphenylsulfide. The conductive material may contain at least one element selected from the Group I elements consisting of nickel (Ni), tin (Sn), copper (Cu), gold (Au) and silver (Ag).

The image sensor package 110 may have a terminal connected to an internal circuit to supply a power voltage received from a main substrate 200 to the housing 160 through the conductive paste 180.

A structure (e.g., solder balls 170) is formed below the image sensor package 110 to connect the internal circuit of the image sensor package 110 with the main substrate 200 of an electronic apparatus, such as a camera phone, a digital camera and a personal multimedia player (PMP). The solder balls 170 allow the image sensor package 110 to be electrically connected to conductive pads 210 formed on the main substrate 200. The main substrate 200 may be a printed circuit board (PCB), flexible PCB, or rigid flexible PCB.

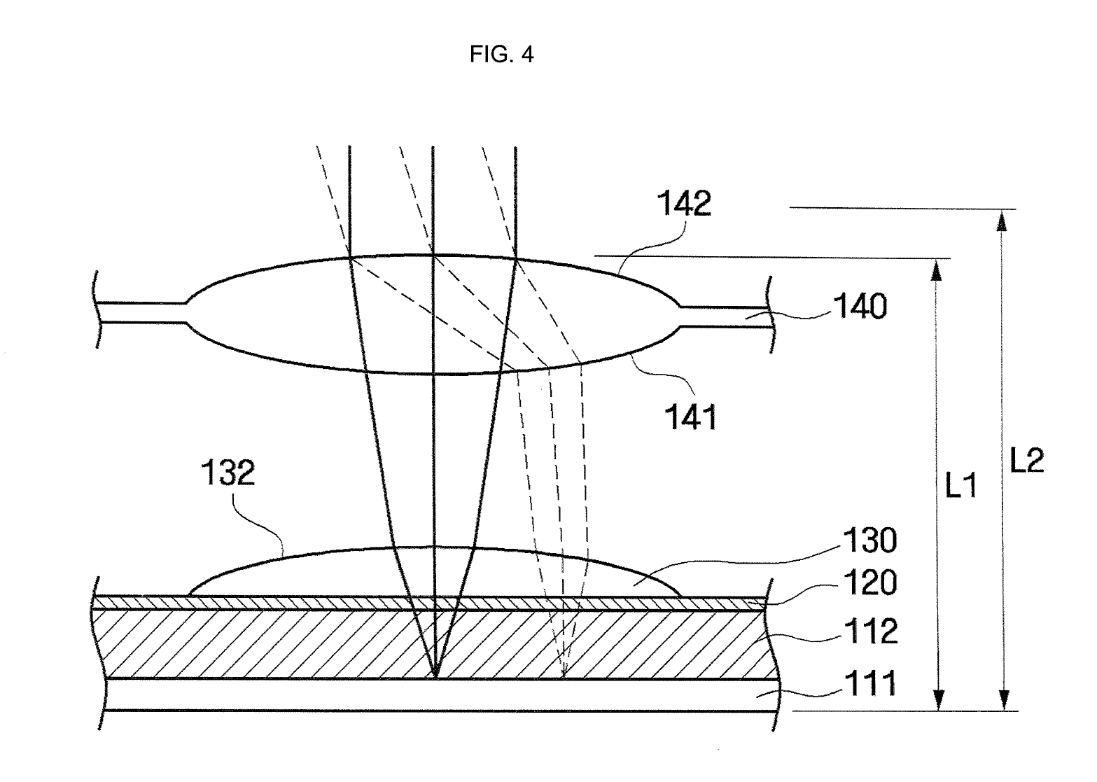

Referring to FIG. 4, the second lens 140, the IR blocking film 120 formed on the chip cover layer 112 and the first lens 130 may form an optical system which includes only three spherical surfaces or aspherical surfaces 132, 141 and 142. The optical system may have an effective focal length (EFL) ranging from above 1.0 to below 1.5, and a ratio of an effective focal length (EFL) to a back focal length (BFL), the ratio (EFL/BFL) ranging from above 1.0 to below 3.0. The optical system formed of the first lens 130, the second lens 140 and the IR blocking film 120 to satisfy the above conditions may be suitable for an electronic apparatus, such as a low resolution camera (e.g., VGA camera).

In a case of using only one lens having two spherical or aspherical surfaces, the back focal length may increase, thereby increasing a total length of the optical system and reducing optical performance. Further, in a case of using two lenses, each lens having two spherical surfaces or aspherical surfaces, there is a problem in which a total length L1 of the optical system increases due to an increase in the number of lenses. Accordingly, in the embodiment of the present general inventive concept, the second lens 140 having two spherical aspherical surfaces 141 and 142 is used to minimize the total length L1 of the optical system. Further, the first lens 130 having one spherical aspherical surface 131 is used in the camera module 100 to correct aberration which has not been corrected completely by the second lens 140 and to reduce an incident angle of light being incident on the image sensor chip 111, and the first lens 130 is coupled with the chip cover layer 112. Accordingly, it is possible to reduce the total length L1 of the optical system without reducing optical performance, thereby reducing a total length 12 of the camera module 100 with respect to the major substrate 200 of an electronic apparatus.

The optical system of FIG. 4 illustrates a light beam A which is incident toward the second lens 140 in a direction substantially perpendicular to a major plane M of the second lens 140. The light beam A is transmitted to a central portion of the image sensor chip 111 of the image sensor package 110 through the second lens 140 and the first lens 130. The optical system also illustrates a light beam B which is incident toward the second lens 140 in a direction having an angle with the direction. The light beam B beam B is transmitted to a side portion of the image sensor chip 111 of the image sensor package 110 through the second lens 140 and the first lens 130 as illustrated in FIG. 4.

Moreover, it is unnecessary to separately install an additional infrared cut filter since the IR blocking film 120 is formed by coating an infrared blocking material on the upper surface of the chip cover layer 112. Accordingly, the total length of the optical system may not be increased due to the above-described installation of an additional infrared cut filter.

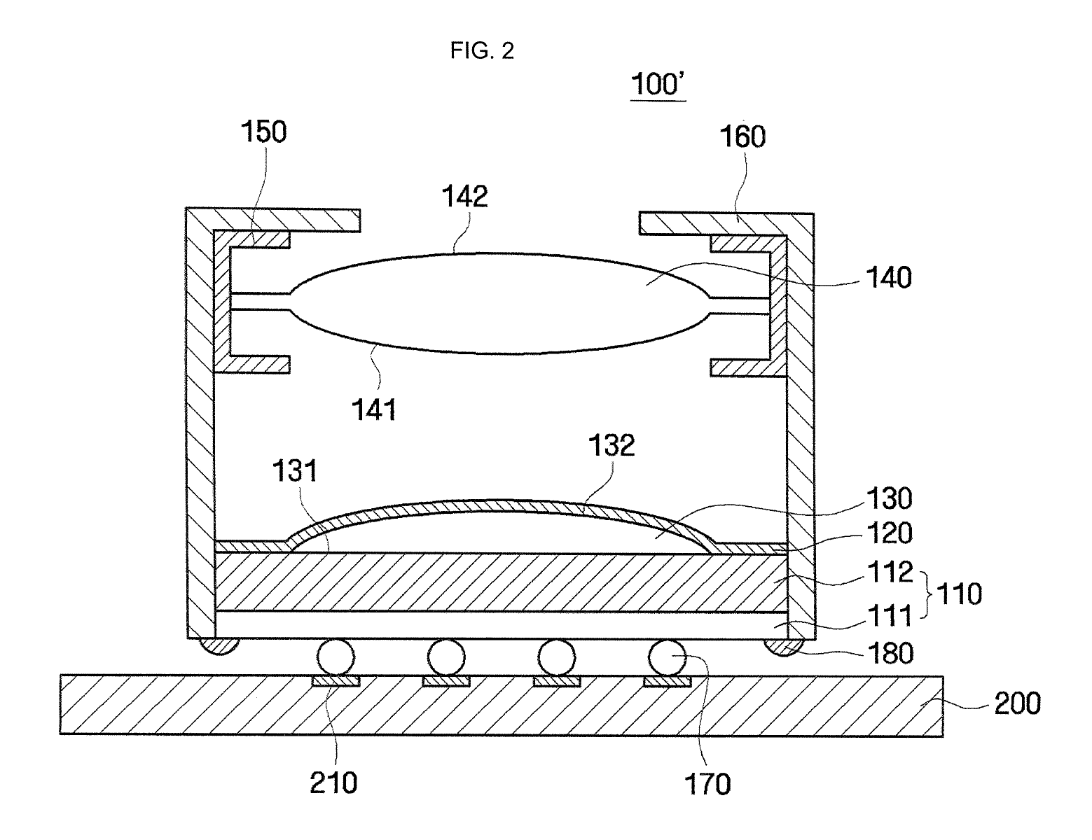

FIG. 2 illustrates a cross sectional view of a camera module 100′ in accordance with another embodiment of the present general inventive concept. For simplicity, components having substantially the same functions as those illustrated in FIG. 1 are designated by the same reference numerals and a detailed description thereof will be omitted.

Referring to FIG. 2, the camera module 100′ of this embodiment is different from the camera module 100 illustrated in FIG. 1 in that the IR blocking film 120 is formed in direct contact with an upper surface of the first lens 130. The IR blocking film 120 is formed in direct contact with the second surface 132 of the first lens 130 which is a spherical surface or aspherical surface.

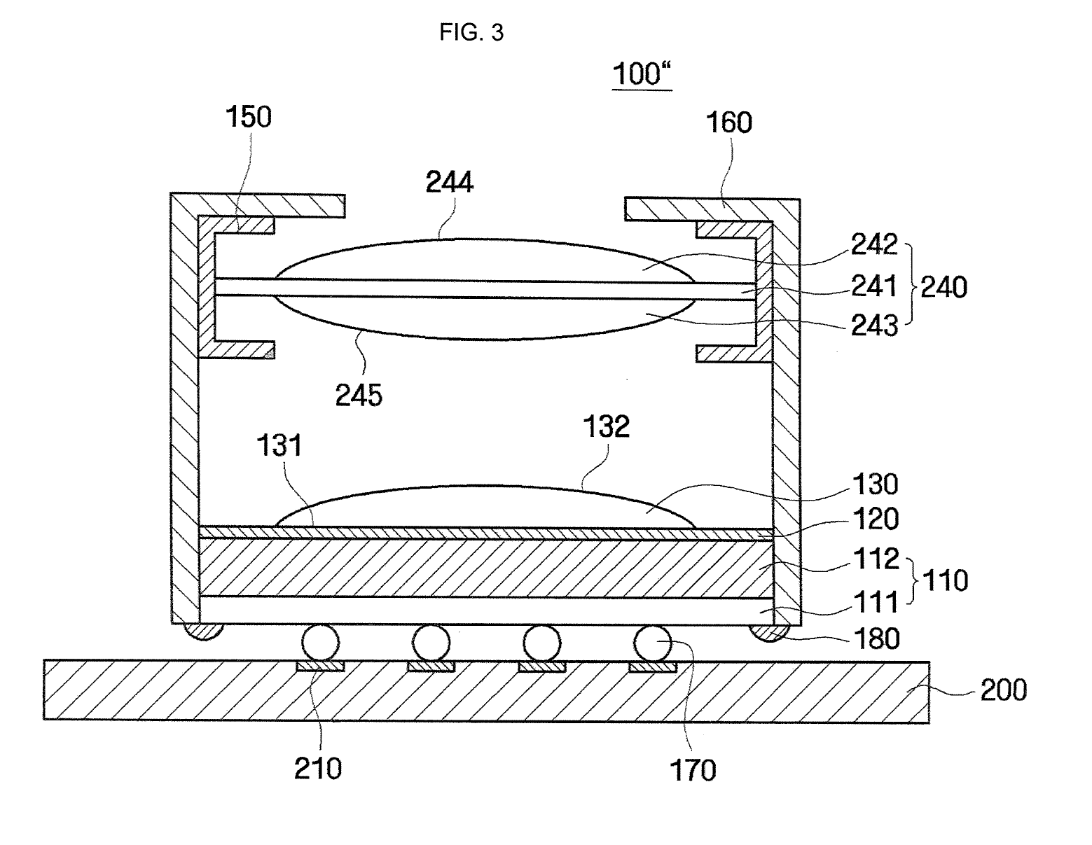

FIG. 3 illustrates a cross sectional view of a camera module 100″ according to another embodiment of the present general inventive concept. For simplicity, components having substantially the same functions as those illustrated in FIG. 1 are designated by the same reference numerals and a detailed description thereof will be omitted.

Referring to FIG. 3, the camera module 100″ of this embodiment is different from the camera module 100 illustrated in FIG. 1 in that a second lens 240 is formed by attaching first and second sub-lenses 242 and 243 on upper and lower surfaces of a base layer 241, respectively. One surface of each of the first and second sub-lenses 242 and 243 is a spherical surface or aspherical surface, and the other surface facing the one surface is a flat surface. A surface 244 of the first sub-lens 242 has a positive refractive power, and a surface 245 of the second sub-lens 243 has a negative refractive power. The first and second sub-lenses 242 and 243 are attached onto the base layer 241 such that the flat surfaces of the first and second sub-lenses 242 and 243 are coupled with the base layer 241.

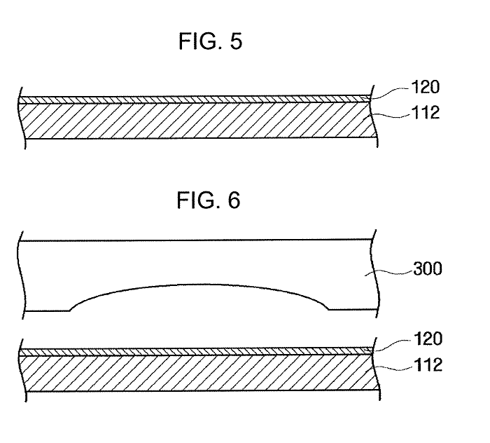

FIGS. 5 to 8 illustrate cross sectional views illustrating a method of forming the infrared blocking film and the first lens on the chip cover layer according to an embodiment of the present general inventive concept. For simplicity, components having substantially the same functions as those illustrated in FIG. 1 are designated by the same reference numerals and a detailed description thereof will be omitted.

Referring to FIGS. 1 and 5, the IR blocking film 120 is formed on the chip cover layer 112. The IR blocking film 120 may be formed by coating an infrared blocking material on the upper surface of the chip cover layer 112 by using a vacuum thin film deposition method or the like. The IR blocking film 120 may be formed by alternately depositing materials having different refractive indexes, e.g., TiO₂/SiO₂ or Ta₂O₅/SiO₂.

Referring to FIG. 6, a mold 300 engraved with the second surface 132 of the first lens 130 (see FIG. 1) is prepared. The mold 300 may be formed of metal, glass or the like. An engraved surface of the mold 300 is arranged to face the IR blocking film 120.

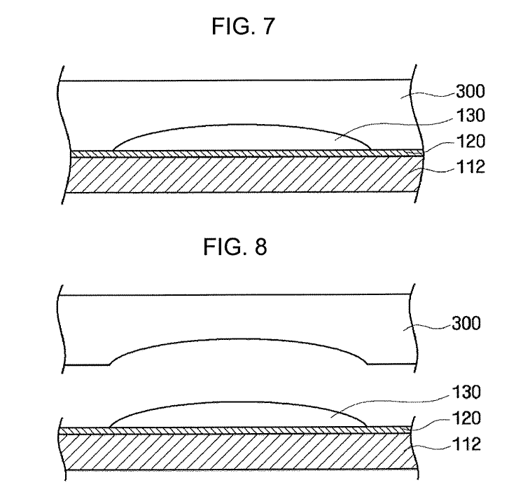

Referring to FIG. 7, after the mold 300 is coupled with the upper surface of the IR blocking film 120, a lens forming material is filled in a space between the IR blocking film 120 and the engraved surface of the mold 300. The lens forming material may be a photocurable resin. Subsequently, the lens forming material may be cured by irradiating ultraviolet light onto the lens forming material, thereby forming the first lens 130.

Referring to FIG. 8, the mold 300 is separated from the chip cover layer 112 on which the first lens 130 is formed.

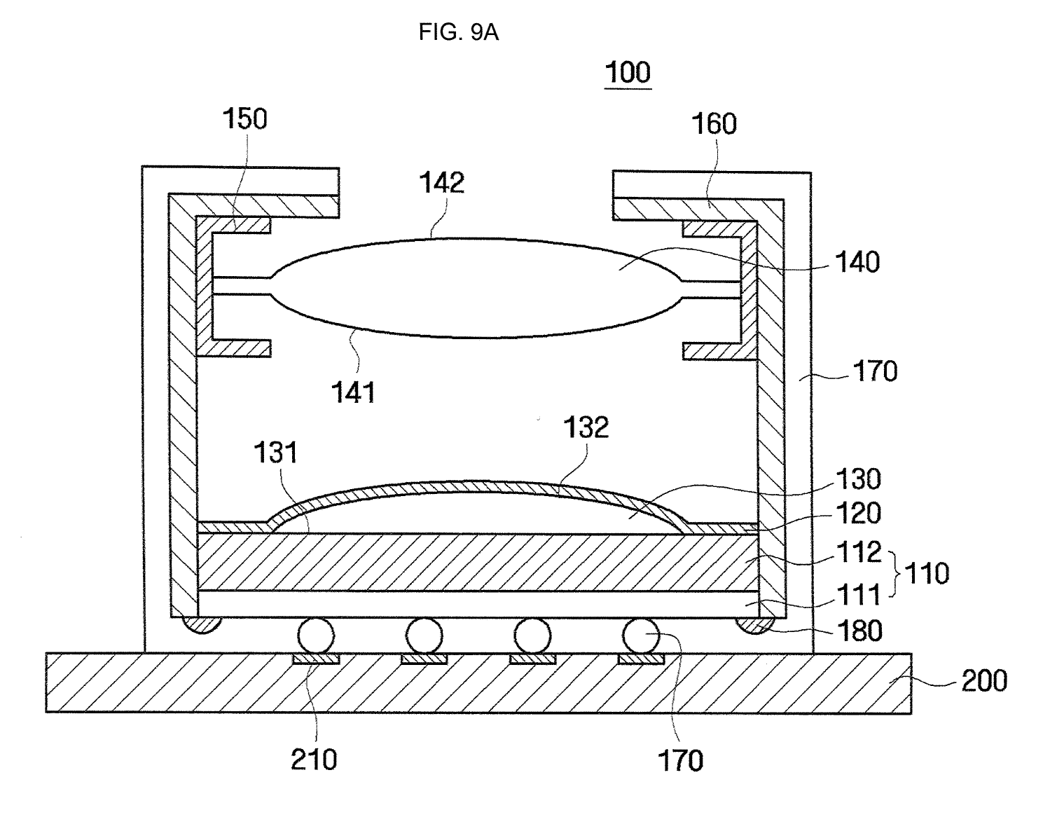

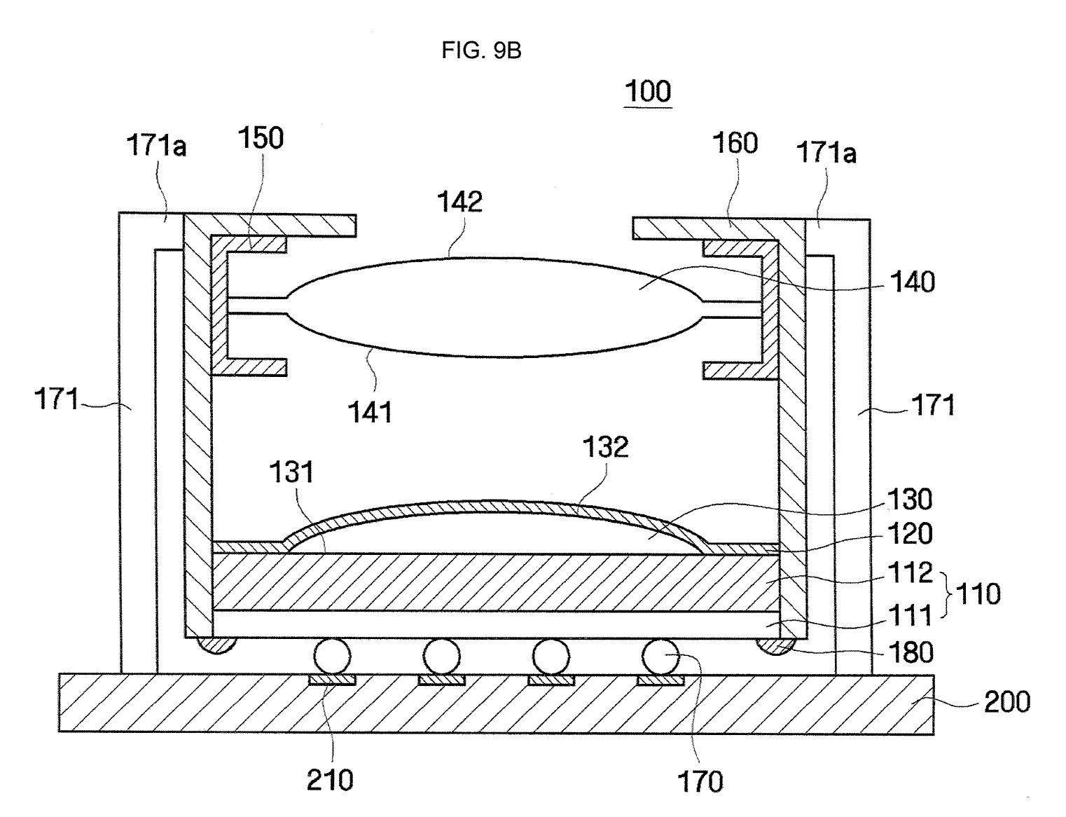

Referring to FIGS. 1 and 9A, the camera module 100 may be formed with an insulation layer 170 in an electronic apparatus. The housing may be formed of a conductive material electrically connected to the image sensor package 110. Accordingly, the insulation layer 170 may be formed to cover the housing 160. The insulation layer 170 may also be formed in a space between the image sensor package 110 and the major substrate 200 of the electronic apparatus. The insulation layer 170 may fixedly hold the camera module 100 with respect to the major substrate 200 within the electronic apparatus. The insulation layer 180 may have a thickness enough to support the camera module 100 with respect to the major substrate 200.

Referring to FIGS. 1 and 9B, the camera module 100 may be include an insulation layer 171 formed on the major substrate 200 of an electronic apparatus. The insulation layer 171 may be formed on the major substrate 200 to be extended in a direction substantially perpendicular to the major substrate 200 to surround or protect the housing of the camera module 100. The insulation layer 171 may have a thickness enough to be installed upward from the major substrate 200. The insulation layer 171 may be spaced-apart from a housing 160 by a distance. The insulation layer 171 may have a height which may correspond to the length L of the camera module 100 or higher than the length L. However, the present general inventive concept is not limited thereto. The insulation layer 171 may further include an end portion 171a protruding from a main body of the insulation layer 171 toward the housing 160. The end portion 171a of the insulation layer 171 may contact an end portion (for example, 160b) of the housing 160 of the camera module 100 to support the housing 160 with respect to the major substrate 200 of the electronic apparatus.

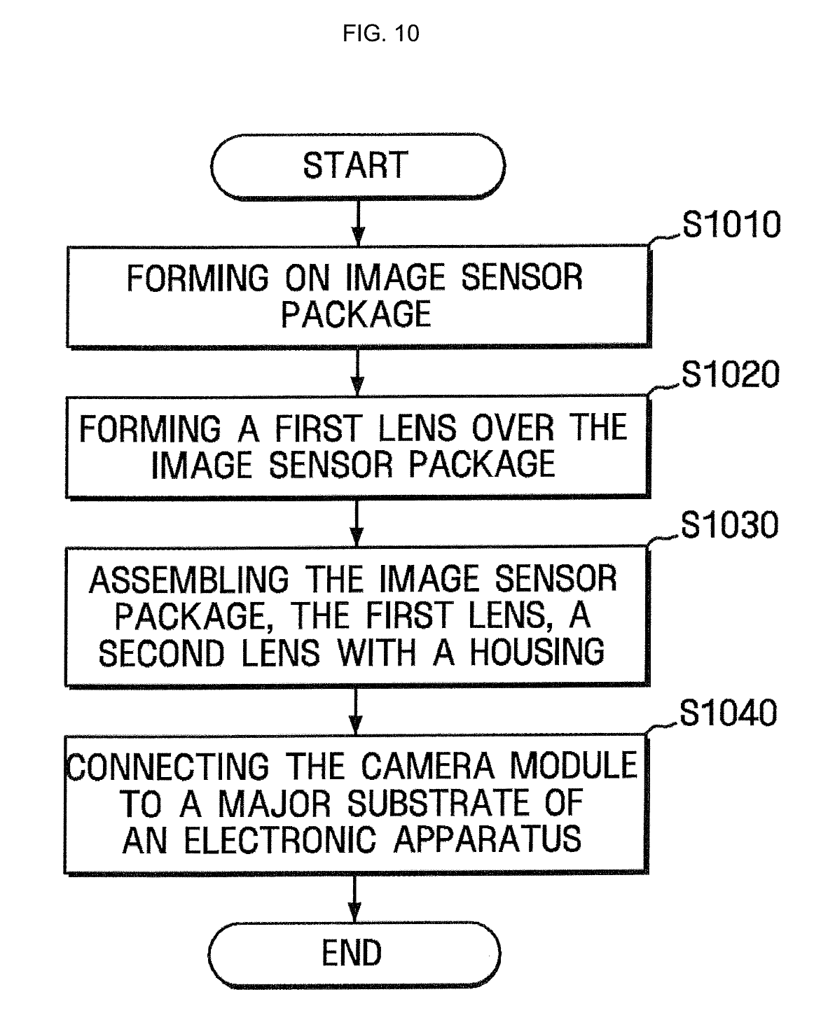

FIG. 10 is a flow chart illustrating a method of forming a camera module having an image sensor package and an electronic apparatus according to an embodiment of the present general inventive concept. Referring to FIGS. 5 through 9, an image sensor package is formed according to the embodiment of FIGS. 5 through 8 at operation 1010. A first lens is formed over the image sensor package at operation 1020. The image sensor package, the first lens, and a second lens (with or without a barrel) are assembled using a housing at operation 1030. And then the above-assembled structure is connected to a major substrate of an electronic apparatus at operation 1040.

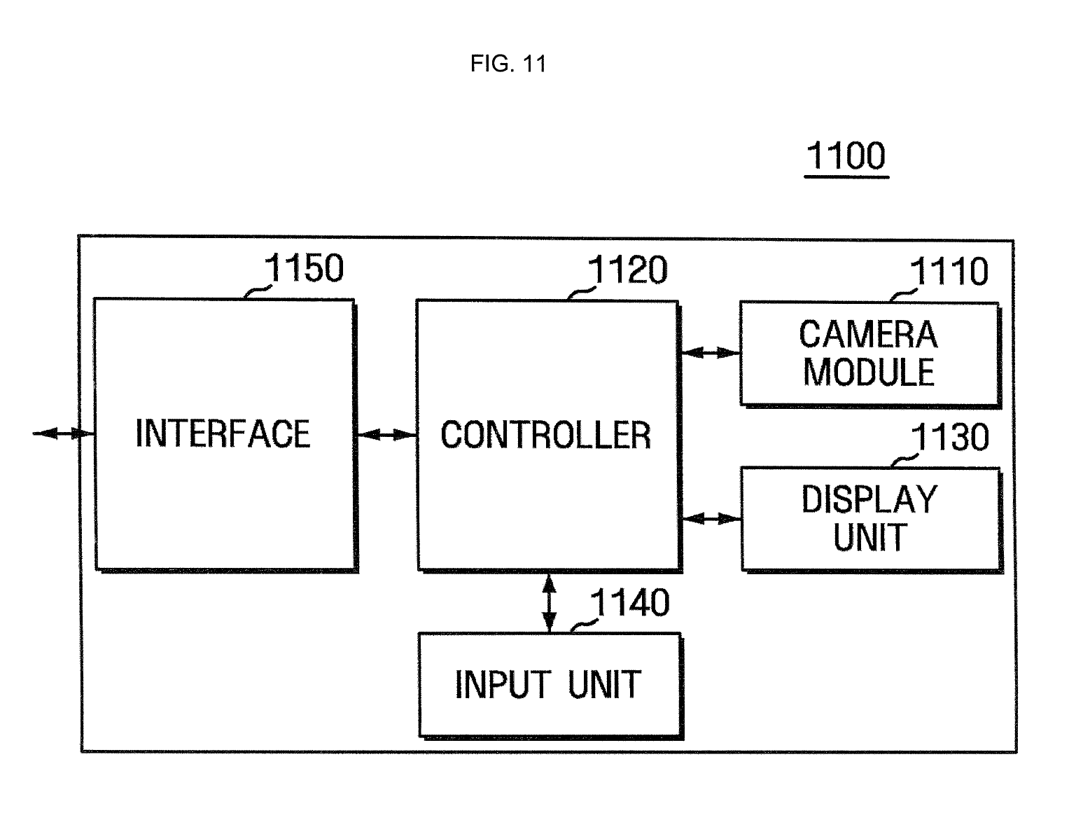

FIG. 11 is a view illustrating an electronic apparatus 1000 having a camera module 1110 according to an embodiment of the present general inventive concept. Referring to FIG. 10, the camera module 1100 may be the camera module 100, 110′, or 100″ as illustrated in FIG. 1, 2, or 3. The electronic apparatus 1100 may include a controller 1120 to receive a signal (data) corresponding to detected image information from the camera module 1100, to process the receive signal, to transmit the processed signal to an external device through an interface (wireless or wired communication interface) 1150. The electronic apparatus 1100 may further include a display unit 1300 to display an image corresponding to the processed signal, and an input unit 1140 to receive an input from a user to control the controller 1120 and/or the display unit 1130. The electronic apparatus may further include a function unit to perform a function of the electronic apparatus, for example, an audio process or output unit.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents The exemplary embodiments should be considered in a descriptive sense only and not for purposes of limitation.

What is claimed is:

1. A camera module comprising:
an image sensor package including an image sensor chip and a chip cover layer protecting the image sensor chip;
a first lens disposed above the image sensor package to be coupled with an upper surface of the chip cover layer;
a second lens disposed above the first lens; and
an infrared blocking film formed in direct contact with one of the upper surface of the chip cover layer and an upper surface of the first lens.

2. The camera module of claim 1, wherein the second lens has two spherical surfaces or aspherical surfaces, and the second lens has one spherical surface or aspherical surface.

3. The camera module of claim 2, wherein the upper surface of the first lens has a positive refractive power and a lower surface of the second lens is a flat surface.

4. The camera module of claim 3, wherein an upper surface of the second lens has a positive refractive power and a lower surface of the second lens has a negative refractive power.

5. The image sensor chip of claim 4, wherein the first lens, the second lens and the infrared blocking film form an optical system having an effective focal length (EFL) ranging from above 1.0 to below 1.5.

6. The image sensor chip of claim 5, wherein the optical system has a ratio of the effective focal length (EFL) to a back focal length (BFL), the ratio (EFL/BFL) ranging from above 1.0 to below 3.0.

7. The camera module of claim 1, wherein the infrared blocking film is in direct contact with the upper surface of the chip cover layer, and the first lens is in direct contact with an upper surface of the infrared blocking film.

8. The camera module of claim 7, wherein the infrared blocking film is formed by coating an infrared blocking material on the upper surface of the chip cover layer.

9. The camera module of claim 8, wherein the infrared blocking material includes TiO₂/SiO₂.

10. The camera module of claim 1, wherein the upper surface and a lower surface of the chip cover layer are flat surfaces and the chip cover layer is formed of glass.

11. The camera module of claim 1, further comprising:
a housing enclosing a side surface of the second lens and a side surface of the image sensor package and the housing includes a conductive material.

12. A camera module comprising:
an image sensor package including an image sensor chip and a chip cover layer to protect the image sensor chip; and
an optical system arranged in a path of light to be incident onto the image sensor chip,
wherein the optical system comprises an objective lens including a first surface having a positive refractive power and a second surface having a negative refractive power, a plano-convex lens coupled with an upper surface of the chip cover layer, and an infrared blocking film formed in direct contact with one of the upper surface of the chip cover layer and an upper surface of the plano-convex lens.

13. The image sensor chip of claim 12, wherein the optical system has an effective focal length (EFL) ranging from above 1.0 to below 1.5.

14. The image sensor chip of claim 13, wherein the optical system has a ratio of the effective focal length (EFL) to a back focal length (BFL), the ratio (EFL/BFL) ranging from above 1.0 to below 3.0.

15. The camera module of claim 12, wherein the infrared blocking film is in direct contact with the upper surface of the chip cover layer, and the plano-convex lens is in direct contact with an upper surface of the infrared blocking film.

16. The camera module of claim 15, wherein the infrared blocking film includes TiO₂/SiO₂.

17. A camera module comprising:
an image sensor package including an image sensor chip and a chip cover layer protecting the image sensor chip;
an optical system arranged in a path of light to be incident onto the image sensor chip, the optical system comprises:
a first lens disposed above the image sensor package to be coupled with an upper surface of the chip cover layer;
a second lens disposed above the first lens; and
an infrared blocking film formed in direct contact with one of the upper surface of the chip cover layer and an upper surface of the first lens.

18. The camera module of claim 17, further comprising:
a housing to accommodate the image sensor package and the optical system.

19. The camera module of claim 18, wherein the optical system comprises a barrel fixed to the second lens, and the barrel is fixed to the housing to support the second lens with respect to the housing and the first lens of the optical system.

20. The camera module of claim 18, further comprising:
an insulation layer formed to protect the housing,
wherein the housing is electrically connected to the image sensor package.
